(19) United States
(12) Patent Application Publication
(10) Pub. No.: US 2023/0186313 A1
(43) Pub. Date: Jun. 15, 2023

(54) ADAPTIVE DAILY WITHDRAWAL LIMITS FOR SMART CHIP ATM TRANSACTIONS

(71) Applicant: Wells Fargo Bank, N.A., San Francisco, CA (US)

(72) Inventor: James Adkins, Pleasanton, CA (US)

(21) Appl. No.: 16/681,280

(22) Filed: Nov. 12, 2019

Related U.S. Application Data
(63) Continuation-in-part of application No. 15/818,544, filed on Nov. 20, 2017, now Pat. No. 11,625,699.
(60) Provisional application No. 62/439,309, filed on Dec. 27, 2016.

(51) Int. Cl. G06Q 20/40; G06Q 20/38; G06Q 20/32; G06Q 20/34; G06Q 20/10

(52) U.S. Cl. CPC G06Q 20/4037; G06Q 20/385; G06Q 20/3226; G06Q 20/341; G06Q 20/382; G06Q 20/1085; G06Q 2220/00

(57) ABSTRACT

A system including a network interface and a processing circuit is provided. The processing circuit includes one or more processors coupled to non-transitory memory. The processing circuit is configured to receive a transaction request from a transaction device. The transaction request associated with a payment card and including a transaction amount. The processing circuit is further configured to determine that the transaction amount would cause a violation of a daily spending limit associated with the payment card. The processing circuit is further configured to generate a one-time-password (OTP) associated with the transaction request. The processing circuit is further configured to provide the OTP to a mobile device of a user. The processing circuit is additionally configured to process the transaction request by applying an adaptive daily spending limit (ADSL) override of the daily spending limit responsive to an indication that the user provided the OTP to the transaction device.

### CROSS-REFERENCE TO RELATED APPLICATION

This application is a continuation-in-part application of U.S. patent application Ser. No. 15/818,544, filed Nov. 20, 2017, which claims priority to U.S. Provisional Patent Application No. 62/439,309 filed Dec. 27, 2016. Both U.S. patent application Ser. No. 15/818,544 and U.S. Provisional Patent Application No. 62/439,309 are incorporated herein by reference in their entirety.

### TECHNICAL FIELD

The present disclosure relates generally systems and methods for applying an adaptive daily spending limit to a debit payment instrument (e.g., a debit card) having an integrated smart chip.

### BACKGROUND

Financial institutions provide various ways for customers to access account information and perform transactions, such as transaction machines, websites, and brick and mortar locations (e.g., retail bank branches). Transaction machines, such as automated teller machines (ATMs), may be accessed at various geographic locations, such as bank locations, convenience stores or other stores to facilitate the account holder's interaction with banking systems. Transaction machines accept transaction cards such as debit cards, credit cards, or stored value cards (e.g., prepaid cards) that are used by account holders to purchase items or services or to obtain funds.

In order to withdraw money from a transaction machine, the transaction card typically includes one or more of a variety of types of technologies that store information used to access the associated account. For example, a payment card, such as a debit card, may include a magnetic stripe. The magnetic stripe comprises magnetic particles that can be arranged to store account information (e.g., the account holder's name, the primary account number, etc.) that can be read by a magnetic stripe reader. As another example, a payment card may include a smart chip, such as a Europay-MasterCard-Visa (EMV) chip, that is programmed with account information that is read by a chip reader. The smart chip includes an integrated circuit or microprocessing chip that is embedded in the transaction card. The EMV standard includes additional protections against fraud that result in chip cards representing a more secure option than magnetic stripe technology.

Often, financial institutions impose a daily spending limit (DSL) on the use of transaction cards. The DSL is generally intended to minimize the risk of fraudulent transactions and is often applied regardless of the balance of the account associated with the transaction card. Though the DSL may be effective in minimizing fraud and its subsequent effects, use of the DSL may also decrease customer satisfaction. For example, transactions denied due to violation of the DSL may require customers to take multiple trips to the ATM on successive days in order to obtain a desired withdrawal amount. This scenario may be particularly unwelcome when the customer has more than sufficient balance in the account to cover the desired withdrawal. Although a customer may request a higher DSL from the financial institution, this usually involves a cumbersome manual process in which the financial institution must assess the institutional risk of a higher limit for a particular customer. Accordingly, systems and methods utilizing the increased security of a smart chip to automatically implement flexible withdrawal limits would be desirable.

### SUMMARY

One embodiment of the disclosure relates to a system including a network interface and a processing circuit. The processing circuit includes one or more processors coupled to non-transitory memory. The processing circuit is configured to receive a transaction request from a transaction device. The transaction request associated with a payment card and including a transaction amount. The processing circuit is further configured to determine that the transaction amount would cause a violation of a daily spending limit associated with the payment card. The processing circuit is further configured to generate a one-time-password (OTP) associated with the transaction request. The processing circuit is further configured to provide the OTP to a mobile device of a user. The processing circuit is additionally configured to process the transaction request by applying an adaptive daily spending limit (ADSL) override of the daily spending limit responsive to an indication that the user provided the OTP to the transaction device.

Another embodiment may be a computer-implemented method. The method includes receiving a transaction request from a transaction device. The transaction request is associated with a payment card and including a transaction amount. The method further includes determining that the transaction amount would exceed a daily spending limit associated with the payment card. The method further includes generating a one-time-password (OTP) associated with the transaction request. The method further includes providing the OTP to a mobile device of a user. The method further includes processing the transaction request by applying an adaptive daily spending limit (ADSL) override of the daily spending limit responsive to an indication that the user provided the OTP to the transaction device.

A further embodiment may be a computer-implemented method. The method includes initiating an authenticated session between the transaction device and a user. The method further includes receiving a transaction request associated with a payment card and including a transaction amount. The method further includes determining that the transaction amount would exceed a daily spending limit associated with the payment card. The method further includes receiving a one-time-password (OTP) for verifying the transaction request. The method further includes completing the transaction request.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a schematic diagram of an adaptive transaction limit management system, according to an example embodiment.

FIG. 2 is a schematic diagram of a process for adapting a transaction limit that may be implemented using the system shown in FIG. 1, according to an example embodiment.

FIG. 3 is a schematic diagram of the process for adapting a transaction limit of FIG. 2 in greater detail, according to an example embodiment.

FIG. 4 is a schematic diagram of an adaptive transaction limit management system, according to an example embodiment.

FIG. 5 is a schematic diagram of a process for completing a transaction requested by a user, according to an example embodiment.

FIG. 6 is a schematic diagram of a process for processing a transaction, according to an example embodiment.

FIG. 7 is a schematic diagram of a process for providing a one-time-password to a mobile device of a user, according to an example embodiment.

### DETAILED DESCRIPTION

Referring to the Figures generally, systems and methods for applying an adaptive daily spending limit (ADSL) to a debit payment instrument (e.g., a debit card) having an integrated smart chip are described. When a debit card holder requests money from an ATM using the debit card, the withdrawal amount (also referred to as a transaction amount) may be restricted because of the application of a daily spending limit (DSL) to the debit account. The DSL is an amount set by a financial institution that represents a maximum amount an account holder may utilize the debit instrument within a given day (e.g., for purchases, for cash withdrawals from an ATM, etc.). In many cases, application of the DSL is an attempt to limit fraudulent activity and the amount of the DSL bears no relationship with the account balance. However, debit cards with integrated smart chips are inherently less susceptible to fraudulent activity than debit cards that do not contain smart chips. Thus, when a debit card holder inserts a debit card containing a smart chip into an ATM and requests approval of a transaction that would otherwise violate a DSL, a financial institution may wish to apply an ADSL to the debit account that permits the completion of the withdrawal transaction. In some arrangements, an ADSL processing circuit within a financial institution computing system may run a series of checks to determine more information about the origin of the withdrawal transaction and the debit account status before determining whether to apply an ADSL to the debit instrument.

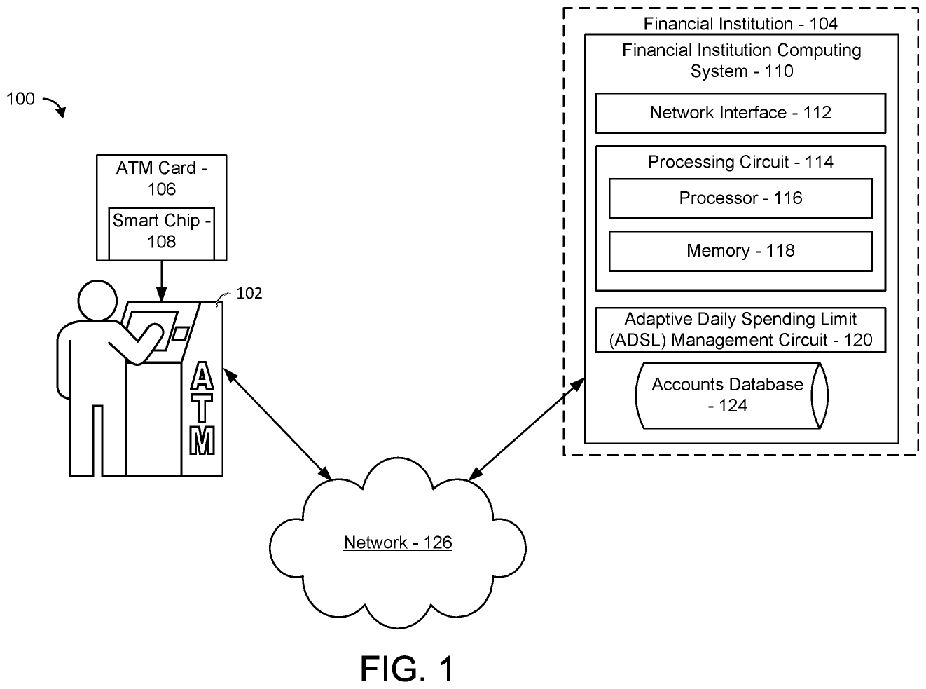

Referring to FIG. 1, an adaptive transaction limit management system 100 is shown, according to an example embodiment. The management system 100 may include, among other systems, an automated teller machine (ATM) 102, and a financial institution computing system 110 within a financial institution 104. The financial institution computing system 110 may include an adaptive daily spending limit (ADSL) management circuit 120 that is integrated within, or otherwise communicable with, the financial institution computing system 110. The ATM 102 and the financial institution 104 may communicate directly or through a network 126, which may include one or more of the Internet, cellular network, Wi-Fi, Wi-Max, a proprietary banking network, or any other type of wired or wireless network.

According to an embodiment of the disclosure, the ATM 102 is a conventional ATM capable of both receiving deposits and dispensing funds. For example, the ATM 102 may be used to perform functions such as withdrawals of paper currency, deposits of paper currency and checks, and monitoring of account balances. In one embodiment, the ATM 102 is owned and operated by the financial institution 104. In other embodiments, the ATM 102 and the financial institution 104 are owned and operated by different entities (e.g., Bank A and Bank B). Account holders may choose to use ATMs owned by different financial institutions as a matter of convenience. For example, an account holder of Bank A may withdraw money from the Bank A account using an ATM owned by Bank B because Bank B's ATM is located closer to the account holder's home or workplace.

It should be noted that ATM 102 is shown as an example of a device that can process a transaction associated with a user. As such, the functionality described regarding ATM 102 may be representative of functionality of other transaction devices for processing transactions. For example, a point-of-sale (POS) device may include some and/or all of the functionality of ATM 102 described herein. In other words, references to ATMs should not be interpreted as limiting on the present disclosure. Transaction devices similar to ATMs that can fulfill transactions are contemplated in the present disclosure.

The ATM 102 includes a transaction card slot configured to receive a transaction card inserted by a user. The ATM 102 may further include a keypad, or similar user input device, containing a number of buttons (e.g., alphanumeric, etc.) configured to receive input (e.g., a personal identification number (PIN)) from a user. Additionally or alternatively, the ATM 102 may incorporate similar user input devices such as touch screens, gesture recognition, and so on. The user utilizes the user input devices, such as the keypad, to navigate a guided user interface (GUI) of the ATM 102. The GUI allows the user to perform the various functions of the ATM 102 and also display information (e.g., prompts, images, text, etc.) to the user. For example, the GUI of the ATM 102 may display account information (e.g., account balance, account number, etc.) to the user.

To initiate a transaction with the ATM 102, a user may insert an ATM card 106 into a transaction card slot of the ATM 102. The ATM card 106 may be one of several types of transaction cards, including a debit card, a credit card, a stored value card, and the like. The transaction cards may be associated with various financial instruments, including a demand deposit account and/or a line of credit. In some embodiments, data used to identify the financial instrument is stored on the ATM card 106 on at least one of a magnetic stripe and/or a smart chip 108 (e.g., an EMV chip). The magnetic stripe stores static data, including the primary account number (PAN) associated with the financial instrument as well as a static card security code. Different payment brands refer to this security code as a card verification value (CVV), card verification code (CVC), card ID (CID), or the like. Because the data is static, the magnetic stripes can be easily cloned or duplicated by thieves using skimming devices or other methods. Thus, transactions cards containing only magnetic stripes are at significant risk for fraud. Though ATM transactions have historically been more secure than point-of-sale (i.e., merchant) transactions due to the heightened security measures surrounding the use of ATMs (e.g., requirement of PIN input, security cameras), the potential for fraud involving ATMs remains, and the risk of fraudulent activity may be significantly reduced through the use of transaction cards containing smart chips.

The smart chip 108 is a secure integrated circuit chip with a microprocessor and memory that is embedded on the ATM card 106 and configured to facilitate dynamic and cryptographic authentication of account information. The microprocessor on the integrated circuit chip may store applications related to the authentication process. Unlike the static data of the magnetic stripe, every time a transaction card containing a smart chip is used, the smart chip creates a unique transaction code (i.e., distinct from the CVV, CVC, or CID stored on the magnetic stripe) that is utilized to verify a given transaction. Without the unique transaction code (or without a transaction code), the transaction based on the account number associated with the transaction card will be denied. Thus, if a thief or fraudster skims an account number associated with a transaction card having a smart chip, the account number cannot be used because the fraudster does not have access to the smart chip that generates the unique transaction code. In some embodiments, the smart chip 108 also includes a chip CVV that is unique from the magnetic stripe CVV. Transaction cards that include a smart chip 108 may alternately be known as smart cards, chip cards, smart-chip cards, chip-enabled smart cards, chip-and-choice cards, EMV smart cards, or EMV cards.

Still referring to FIG. 1, the transaction card slot of the ATM 102 is connected to a card reader. ATM card readers may operate via one of three user actions: swiping, dipping, and inserting. Swiping involves the user passing only the magnetic strip of a transaction card through a reader. Dipping involves quickly inserting and then removing the card from the card reader. Inserting involves inserting the transaction card fully into a card slot, where it is “grabbed” by the reader to remain within the terminal for the duration of the transaction. Because swiping only involves the reader making contact with the magnetic strip and dipping does not permit the reader to make contact with a smart chip for a significant length of time, neither method is suitable for reading data from a smart chip.

Once a user has inserted the ATM card 106 into the ATM 102 and the card reader mechanism has read data from the smart chip 108, the ATM 102 identifies the applications stored on the smart chip 108 and selects an appropriate application or applications to perform a preliminary risk management process. In some embodiments, the preliminary risk management process includes a data authentication process and cardholder verification checks (e.g., PIN entry). In some embodiments, the authentication and verification processes include an online card authentication process.

After the card has been authenticated, details of the withdrawal transaction and financial instrument data obtained from the smart chip 108 may be transmitted to the financial institution 104 via the network 126. In some embodiments, data transmitted to the financial institution 104 may comprise a data packet. In various embodiments, the data packet may include a cryptogram and a string of numbers in which the values of certain fields in the string comprise details about the transaction. For example, the value of one field in the string may indicate that the transaction card initiating the transaction is a smart chip (e.g., EMV) card. Other fields may indicate that the transaction was acquired at a chip-capable terminal and/or that the card data passed data and cardholder verification procedures.

The financial institution 104 is an entity that manages the financial instrument held by the account holder requesting funds from the ATM 102. For example, the financial institution 104 may be a bank, credit union, a payment services company, a financial service provider, or other similar entities. The financial institution 104 contains an associated financial institution computing system 110. The financial institution computing system 110 includes, among other systems, a network interface 112, a processing circuit 114, an adaptive daily spending limit (ADSL) management circuit 120, and an accounts database 124.

The processing circuit 114 includes a processor 116 and memory 118. The processor 116 may be implemented as one or more application specific integrated circuits (ASICs), field programmable gate arrays (FPGAs), a group of processing components, or other suitable electronic processing components. Memory 118 may be one or more devices (e.g., RAM, ROM, Flash memory, hard disk storage) for storing data and/or computer code for completing and/or facilitating the various processes described herein. Memory 118 may be or include non-transient volatile memory, non-volatile memory, and non-transitory computer storage media. Memory 118 may include database components, object code components, script components, or any other type of information structure for supporting the various activities and information structures described herein. Memory 118 may be communicably coupled to the processor 116 and include computer code or instructions for executing one or more processes described herein.

Still referring to FIG. 1, the financial institution computing system 110 is further shown to include an adaptive daily spending limit (ADSL) management circuit 120. The ADSL management circuit 120 is configured to determine whether an ADSL should be applied to an account when a withdrawal request is received from the ATM 102 that would otherwise violate a daily spending limit (DSL). The DSL is an amount set by the financial institution 104 that represents the maximum amount of currency that an account holder may utilize a transaction card for within a given day. For example, the transaction card may have a DSL of $1,000, meaning that if the account holder uses the transaction card to make a purchase for $910 and then attempts to withdraw $100 from an ATM on the same day, the ATM withdrawal transaction will be denied. In some embodiments, the DSL is determined by the financial institution 104 without reference to the balance of the account associated with the transaction card. Rigid application of the DSL may be frustrating and inconvenient to account holders, particularly when the DSL is low relative to the account balance of the financial instrument. For example, returning to the example above, the $100 ATM withdrawal transaction may be denied on the basis of exceeding the DSL even if the account holder is requesting funds from an account with a balance of $25,000.

An ADSL is an override to the DSL that may be applied to a financial instrument in response to a withdrawal transaction when the risk to the financial institution is low. For example, risk to a financial institution may be minimized when the withdrawal transaction originates from a transaction card containing a smart chip used in an ATM owned and operated by the financial institution. In some embodiments, the amount of the ADSL is configurable by the financial institution 104 based on the type of financial instrument, the account holder's transaction history with the financial institution, categorization of the account holder into a particular customer group, or any other criteria determined by the financial institution. For example, the financial institution 104 may wish to set a higher ADSL for its business customers than its regular consumers (e.g., $1,000 added to the DSL for business customers vs. $500 added to the DSL for regular consumers). It should be noted that the terms “customer” and “user” may be used interchangeably herein.

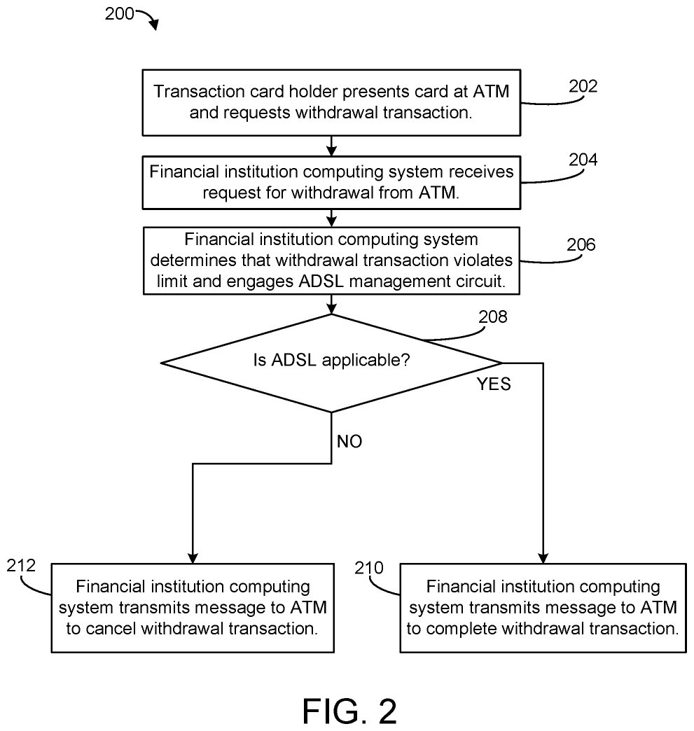

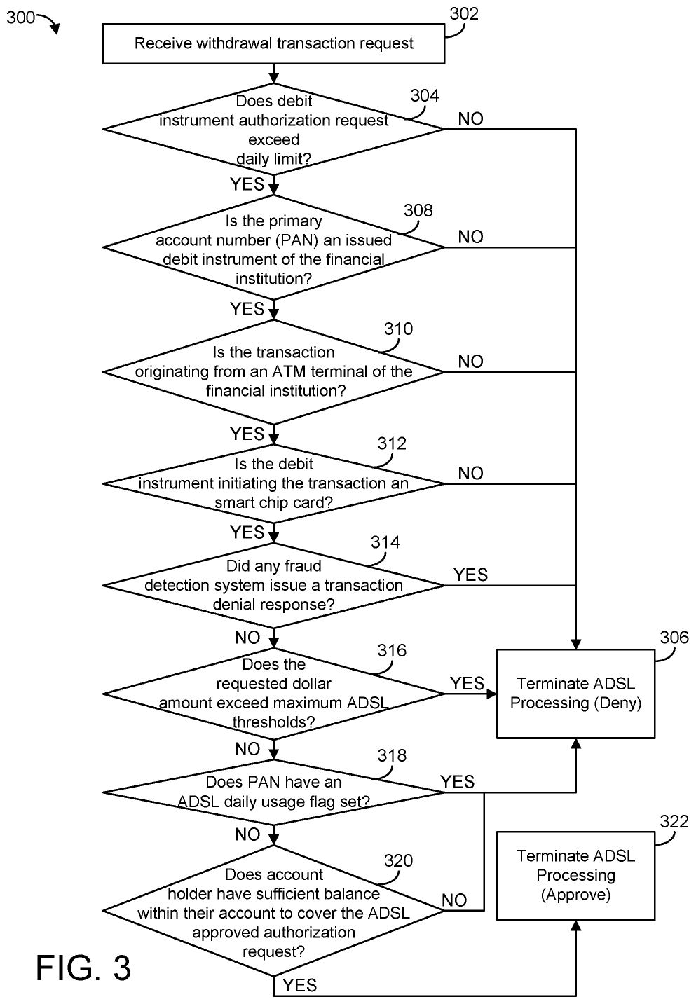

The ADSL management circuit 120 determines whether to apply an ADSL to a transaction that would otherwise be denied for violating the DSL. If the ADSL management circuit 120 determines that an ADSL should be applied, the funds requested by the transaction card holder are deducted from the account, even though the transaction would otherwise violate the DSL. If the ADSL management circuit 120 determines that an ADSL should not be applied, the transaction is cancelled. This process is described in greater detail below with respect to FIGS. 2 and 3.

The financial institution computing system 110 further includes an accounts database 124. The accounts database 124 is configured to store all information relating to the accounts associated with the transaction cards, including any information required by the ADSL management circuit 120 or the processing circuit 114. This information may include, but is not limited to, account numbers (i.e., PANs), account balance information, authentication and verification data, and transaction logs.

Referring now to FIG. 2, a process 200 is shown for changing a withdrawal transaction limit via application of an ADSL, according to an example embodiment. The process 200 may be performed by the financial institution computing system 110 (e.g., by the ADSL management circuit 120) of the management system 100 shown in FIG. 1. The transaction card holder presents the transaction card 106 at ATM 102 by inserting the card into the card slot at 202. Once the card reader of the ATM 102 has obtained the account information from the card (e.g., an account number associated with the card, dynamic data stored on the smart chip 108, etc.) and after the card holder inserting the card 106 has been authenticated (e.g., by providing a PIN, by providing a biometric, etc.), the card holder is presented with a number of transaction options displayed via the user interface of the ATM 102. The card holder additionally selects a withdrawal transaction of paper currency at 202. This request may be transmitted via the network 126, and received by the financial institution computing system 110 at 204.

At 206, the financial institution computing system 110 determines that the requested withdrawal amount violates the DSL and transmits information regarding the withdrawal transaction to the ADSL management circuit 120. At 208, the ADSL management circuit 120 determines whether an ADSL should be applied to the requested withdrawal transaction. The process of determining whether an ADSL should be applied will be described in greater detail below with reference to FIG. 3. If the ADSL management circuit 120 determines an ADSL may be applied to the account associated with the withdrawal transaction, the financial institution computing system 110 transmits a message at 210 to the ATM 102 indicating that the withdrawal transaction should be approved, and process 200 terminates with ATM 102 dispensing the requested funds.

However, if the ADSL management circuit 120 determines at 208 that an ADSL should not be applied to the withdrawal transaction, the financial institution computing system 110 transmits a message to the ATM 102 at 212 indicating the withdrawal transaction should be cancelled. In some embodiments, the ATM 102 may display a message notifying the user of the reason for the cancellation. For example, the ATM 102 may display a “DAILY LIMIT EXCEEDED” message. This message may inform the transaction card holder that the transaction was not cancelled because the account contained insufficient funds or because fraudulent activity was detected on the account.

Referring now to FIG. 3, a process 300 is shown for determining whether to apply an adaptive transaction limit to a withdrawal transaction, according to an example embodiment. The process 300 may be performed using the adaptive transaction limit management system 100 shown in FIG. 1. Specifically, the process 300 may be performed using ADSL management circuit 120 of the financial institution computing system 110, which is described in further detail herein.

The ADSL management circuit 120 receives a request to evaluate a transaction for ADSL eligibility at 302. In an example embodiment, this request is received by the financial institution computing system 110 via the network 126 after a debit instrument holder inserts the ATM card 106 containing the smart chip 108 into the ATM 102 and requests a withdrawal transaction. In some embodiments, step 302 is identical or substantially similar to step 204 of the process 200.

The ADSL management circuit 120 verifies that the withdrawal transaction request would cause the debit instrument holder to exceed a daily spending limit at 304. For example, a debit instrument holder may request a $50 withdrawal from an ATM when the debit instrument holder's DSL is $500 and no other transactions involving the debit instrument have been made the same day. In this example, the financial institution computing system 110 would not decline the transaction for exceeding a DSL and there is no need to determine whether an ADSL should apply. The ADSL management circuit 120 therefore terminates ADSL processing at 306.

If the ADSL management circuit 120 terminates ADSL processing at 306, several events may subsequently occur. Depending on the circumstances of the termination, the ADSL management circuit 120 may send a transaction denial message to the processing circuit 114, and the processing circuit 114 may transmit a transaction denial message that is displayed on the ATM 102. The ADSL management circuit 120 may also set an ADSL indicator value in a transaction log to note the termination of ADSL processing. In some embodiments, the transaction log is stored in the accounts database 124 of the financial institution computing system 110. For example, the ADSL management circuit 120 may set a value of “AD” in the transaction log to indicate that ADSL processing occurred, but the transaction was denied.

Returning to an alternative example at 304, if a debit instrument holder with a $500 daily spending limit requests $50 from an ATM when the daily transactions involving the debit instrument total $475, the financial institution computing system 110 will deny the transaction on a preliminary basis, and process 300 will continue to 308. At 308, the ADSL management circuit 120 determines whether the primary account number (PAN) associated with the financial instrument is a PAN issued by the financial institution 104. For example, if Bank A (i.e., the financial institution 104) receives a withdrawal request originating at one of Bank A's ATMs involving a debit instrument with an associated PAN issued by Bank B, Bank A may have neither the authority nor the inclination to apply an ADSL to the debit instrument associated with Bank B. In this scenario, process 300 proceeds to terminate ADSL processing at step 306. However, if the debit instrument's associated PAN is also issued from Bank A, process 300 may continue to step 310.

At 310, the ADSL management circuit 120 determines whether the withdrawal transaction originated from an ATM 102 associated with the financial institution 104. In one example, Bank A (i.e., the financial institution 104) may receive a withdrawal request from a debit instrument with an associated PAN issued by Bank A, but the transaction may originate from an ATM 102 associated with Bank B. In another example, the withdrawal transaction may be received from a source other than an ATM 102 (e.g., a merchant point-of-sale (POS) terminal). If the ADSL management circuit 120 determines that the withdrawal transaction originated from a source other an ATM 102 associated with the financial institution 104, process 300 terminates at 306. However, if the ADSL management circuit 120 determines that the transaction did originate from an ATM 102 associated with the financial institution 104, process 300 may proceed to 312.

Still referring to FIG. 3, at 312, the ADSL management circuit 120 verifies that the debit instrument initiating the transaction is a smart chip card. As described above with reference to FIG. 1, in some embodiments, the value of one field in the string of the data packet transmitted to the financial institution computing system 110 from the ATM 102 may indicate that the transaction card initiating the transaction is an integrated chip (e.g., EMV) card. Other fields may indicate that the transaction was acquired at a chip-capable terminal and/or that the card data passed authorization procedures. If the ADSL management circuit 120 verifies the debit instrument initiating the transaction is a smart chip card, process 300 continues to 314. If the debit instrument is not a smart chip card, process 300 terminates at 306 because non-chip card transactions are inherently less secure than smart chip transactions (e.g., the transaction may have been initiated by a fraudster using skimmed card data).

At 314, the ADSL management circuit 120 determines whether any fraud detection system within the financial institution computing system 110 has denied the transaction. In some embodiments, fraud detection may be based on a comparison of the geographic location associated with the account stored in the accounts database 124 and the geographic location of the ATM 102 requesting the withdrawal transaction. For example, if an account holder opens and primarily uses an account in geographic region A and the financial institution computing system 110 detects that the withdrawal transaction originates in geographic B, if geographic region B is a significant distance from geographic region A (e.g., different states or countries), the withdrawal transaction may be flagged as potentially fraudulent. In other embodiments, fraud may be detected if transactions prior to the requested withdrawal transaction are highly uncharacteristic when compared with the financial instrument's past patterns of usage. If the ADSL management circuit 120 determines that a fraud detection system has denied the transaction, process 300 terminates at 306. Alternatively, if no system within the financial institution computing system 110 has detected fraud, process 300 will continue to 316.

Referring now to 316 of the process 300, the ADSL management circuit 120 determines whether the requested withdrawal transaction amount exceeds maximum ADSL thresholds. In some embodiments, the amount requested by the account holder exceeds both the DSL and the permitted amount when an ADSL is applied. For example, if the DSL for a financial instrument is $1,000, and the ADSL set by the financial institution 104 for this type of financial instrument is $500, application of an ADSL to the DSL would not be suitable if the account holder requests a withdrawal transaction of $2,000. Thus, if the amount of the withdrawal transaction exceeds the amount permitted by an applied ADSL, process 300 terminates at 306. If the withdrawal amount does not exceed the limits of the ADSL, process 300 continues to 318.

At 318, the ADSL management circuit 120 determines whether the PAN associated with the transaction has a ADSL flag set indicating that an ADSL has been applied. The ADSL flag may be used to limit the frequency in which an ADSL is applied to an account (e.g., once per day). In some embodiments, the ADSL daily usage flag comprises a value (e.g., “0” if no ADSL has been applied to the account, “1” if an ADSL has been applied once) in the account data packet transmitted from the ATM 102 to the financial institution computing system 110. In some embodiments, multiple applications of an ADSL in a single day may be permitted by financial institution 104, and the value of the ADSL daily usage flag may be incremented each time an ADSL is applied.

If the ADSL management circuit 120 determines from the ADSL daily usage flag that an ADSL has already been applied to a prior transaction on the day of the withdrawal request, process 300 terminates at 306. In some embodiments, terminating the process at this step includes the ADSL management circuit 120 logging an indicator (e.g., “AE”) in the transaction log to indicate that the transaction used ADSL logic, but the withdrawal transaction was denied because the daily usage flag was already set. If the ADSL management circuit 120 detects that the ADSL daily usage flag is not set in the account data received from the ATM 102, the process 300 continues to 320. Alternatively, if the value of the ADSL daily usage flag does not exceed the limit imposed by the financial institution 104, process 300 may also proceed to 320.

At 320, the ADSL management circuit 120 determines whether the account holder has sufficient balance within the account to cover the requested amount if an ADSL was applied to the withdrawal transaction. For example, if the financial institution 104 has a default ADSL of $500 and an account holder requests a withdrawal of $400, the transaction will be denied if the account balance is only $300, even though the requested withdrawal of $400 is within the $500 ADSL. If the ADSL management circuit 120 determines that the account contains insufficient funds to complete the withdrawal transaction, process 300 proceeds to terminate at 306. However, if the account has sufficient balance to cover the requested transaction, process 300 proceeds to 322.

At 322, ADSL processing is terminated with a determination to approve the withdrawal amount via application of an ADSL to the financial instrument associated with the withdrawal transaction. Approval of the ADSL causes the ADSL management circuit 120 to generate an approval message that is transmitted to the financial institution computing system 110, which in turn transmits an approval to the ATM 102 via the network 126. After the ATM 102 receives the approval message, it dispenses the requested funds as described with reference to 210 above. Approval of the ADSL may also prompt the management circuit 120 to set or increment the value of the ADSL daily usage flag in the account data. In some embodiments, the management circuit 120 may additionally or alternatively set an indicator value in the transaction log (e.g., “AA”) to identify that the transaction utilized ADSL processing and an ADSL was applied to the account to complete the transaction.

In some embodiments, ADSL management circuit 120 may not complete each of the checks detailed in 304-320 of process 300 in determining whether to apply an ADSL. For example, ADSL management circuit 120 may omit one or two of the checks detailed in 304-320 (e.g., if financial institution 104 deems the risk of fraud to be low, ADSL management circuit 120 may bypass the fraud detection check in 314). In other embodiments, ADSL management circuit 120 may omit nearly all of the checks detailed in 304-320. For example, financial institution 104 may determine that it is sufficient to perform a bare minimum of checks (e.g., only checking whether the debit instrument is a smart chip card at 312 and whether the account holder has sufficient balance to cover the ADSL at 320) before determining whether to apply an ADSL.

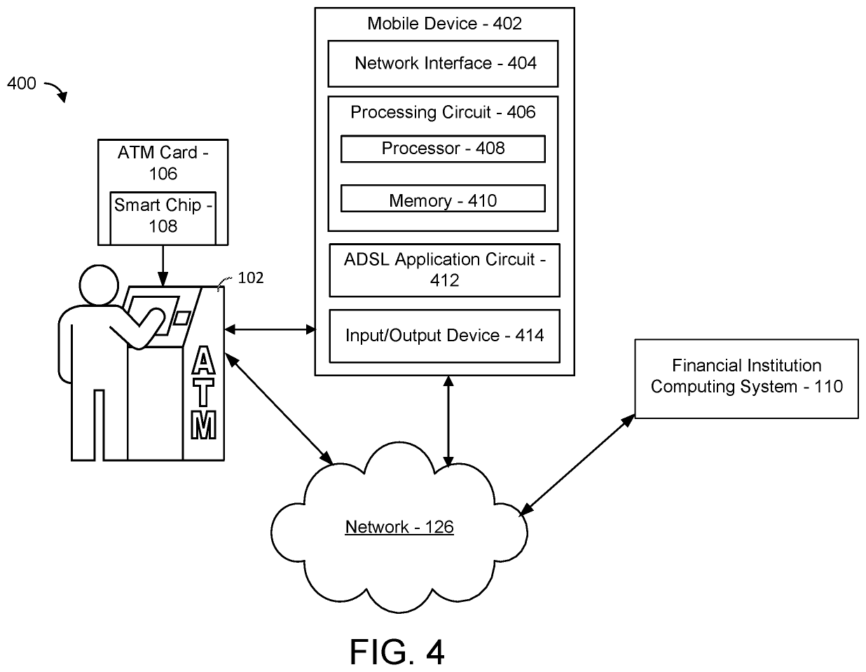

Referring now to FIG. 4, an adaptive transaction limit management system 400 is shown, according to an example embodiment. In some embodiments, adaptive transaction limit management system 400 is similar to and/or the same as adaptive transaction limit management system 100 as described in greater detail above with reference to FIG. 1. As such, adaptive transaction limit management system 400 is shown to include, among other systems, ATM 102, network 126, and financial institution computing system 110. Adaptive transaction limit management system 400 is also shown to include a mobile device 402. Mobile device 402, as described in detail below, can provide additional functionality and security to adaptive transaction limit management system 400 in processing ADSL overrides for users.

Mobile device 402 can be any type of mobile device that a user (e.g., the user interacting with ATM 102) may have in their possession. For example, mobile device 402 may be a mobile phone (e.g., a smart phone), a smart watch, smart glasses, a personal digital assistant (PDA) device, a tablet, and/or any other mobile device that can provide information to a user. In effect, mobile device 402 can allow the user to send and receive data from other systems/devices in adaptive transaction limit management system 400. Mobile device 402 can be registered/verified for use with financial institution computing system 110. Specifically, mobile device 402 can be associated with an account of the user and can be configured to receive one-time-passwords for verifying transactions that require ADSL overrides. In this way, financial institution computing system 110 can rely on mobile device 402 being used by the particular user and can confirm an identity of the user via mobile device 402. Said registration may be based on a phone number of mobile device 402, a mobile device identifier (e.g., a media access control (MAC) address), etc.

Mobile device 402 is shown to include a network interface 404 enabling mobile device 402 to exchange information over network 126, a processing circuit 406, an adaptive daily spending limit application circuit 412, and an input/output device 414. Network interface 404 can include program logic that facilitates connection of mobile device 402 to network 126. Network interface 404 can support communication between mobile device 402 and other systems, such as financial institution computing system 110. For example, network interface 404 can include a cellular modem, a Bluetooth transceiver, a Bluetooth beacon, a radio-frequency identification (RFID) transceiver, and a near-field communication (NFC) transmitter. In some embodiments, network interface 404 includes the hardware and machine-readable media sufficient to support communication over multiple channels of data communication. Further, in some embodiments, network interface 404 includes cryptography capabilities to establish a secure or relatively secure communication session between mobile device 402 and financial institution computing system 110. In this regard, information (e.g., account information, login information, financial data, and/or other types of data) may be encrypted and transmitted to prevent or substantially prevent a threat of hacking.

Processing circuit 406 is shown to include a processor 408 and memory 410. Processor 408 may be implemented as one or more application specific integrated circuits (ASICs), field programmable gate arrays (FPGAs), a group of processing components, or other suitable electronic processing components. Memory 410 may be one or more devices (e.g., RAM, ROM, Flash memory, hard disk storage) for storing data and/or computer code for completing and/or facilitating the various processes described herein. Memory 410 may be or include non-transient volatile memory, non-volatile memory, and non-transitory computer storage media. Memory 410 may include database components, object code components, script components, or any other type of information structure for supporting the various activities and information structures described herein. Memory 410 may be communicably coupled to processor 408 and include computer code or instructions for executing one or more processes described herein.

Mobile device 402 is also shown to include an input/output (I/O) device 414. In some embodiments, the user interacts with ADSL application circuit 412, described in detail below, via I/O device 414. I/O device 414 may include hardware and associated logics that enable the user to exchange information with mobile device 402. An input component of I/O device 414 can allow the user to provide information to mobile device 402. The input component may include various hardware and associated logics such as, for example, a mechanical keyboard, a mechanical mouse, a touchscreen, a microphone, a camera, a fingerprint scanner, etc. Likewise, an output component of I/O device 414 can include hardware and associated logics that allow mobile device 402 to provide information to the user. For example, the output component may include a digital display, a speaker, illuminating icons, LEDs, etc. In this way, the user can interact with ADSL application circuit 412. For example, the user may be provided account-specific information received from financial institution computing system 110 via I/O device 414.

Mobile device 402 is shown to include ADSL application circuit 412 that is integrated within, or otherwise communicable with, mobile device 402. In some embodiments, ADSL application circuit 412 is implemented as a mobile application provided by financial institution computing system 110. For example, financial institution computing system 110 may directly provide the mobile application to mobile device 402 thereby resulting in ADSL application circuit 412 being installed on mobile device 402. In some embodiments, mobile device 402 downloads ADSL application circuit 412 from a third-party (e.g., an app store) which causes ADSL application circuit 412 to be installed on mobile device 402. In some embodiments, mobile device 402 is provided with ADSL application circuit 412 preinstalled. In effect, ADSL application circuit 412 can be downloaded by mobile device 402 prior to its usage and hard-coded into memory 410.

In some embodiments, ADSL application circuit 412 is structured to generate and provide displays to mobile device 402 (e.g., to I/O device 414 described below) that enable the user to view account information, passwords for accessing ATM 102, etc. Accordingly, ADSL application circuit 412 can be configured to send information to and receive information from financial institution computing system 110 (e.g., via network interface 404). In some embodiments, ADSL application circuit 412 is implemented via a web browser as a web-based interface application. In some embodiments, ADSL application circuit 412 is a text messaging application that allows financial institution computing system 110 to send text (e.g., SMS) messages to mobile device 402 indicating various information. In some embodiments, ADSL application circuit 412 includes an application programming interface (API) and/or a software development kit (SDK) that facilitate the integration of other applications with ADSL application circuit 412.

In some embodiments, a core feature of ADSL application circuit 412 is to facilitate authentication of the user in the adaptive transaction limit management system 400. Particularly, ADSL application circuit 412 can send and receive data used to confirm the user's identity for purposes of processing a request to exceed the user's DSL. If the user is attempting to exceed the DSL, the user may be required to confirm their identity via additional authentication. Requiring further authentication can provide additional security for adaptive transaction limit management system 400 by verifying that the user attempting to exceed the DSL is not another entity (e.g., a malicious individual).

As described above, if the user is attempting to make a withdrawal from an account via ATM 102, ATM 102 can provide a transaction request to financial institution computing system 110. Said transaction request can be provided to financial institution computing system 110 by ATM 102 over network 126. Responsive to the transaction request, ADSL management circuit 120 may determine whether the withdrawal would exceed the DSL and, if the withdrawal would exceed the DSL, can make a determination regarding whether an ADSL override should be considered. In some embodiments, only certain users may qualify to override their particular DSL via an ADSL override. For example, financial institution 104 may set a minimum balance requirement (e.g., $500, $1000, $10000, etc.) such that only users that have a balance in an account (e.g., a checking account, a savings account, etc.) that is equal to or greater than the minimum balance requirement can override the DSL. As another example, financial institution 104 may only allow users with a business account (e.g., as opposed to a personal account) to exceed the DSL. Other criteria for determining whether to consider an ADSL override can include, for example, whether the user is using a payment card with a smart chip or a magnetic strip, an age of an account of the user, a user's ability to access a registered mobile device (e.g., mobile device 402), whether the present transaction is a stand-in transaction, etc. As should be appreciated, financial institution 104 and/or financial institution computing system 110 can set various requirements/criteria for determining whether an ADSL override should be considered.

If ADSL management circuit 120 determines the user does not qualify for exceeding their DSL, the transaction request may be rejected. If the transaction request is rejected, ADSL management circuit 120 can provide a rejection notification to ATM 102 via network 126. Based on the rejection notification, ATM 102 can display an indication to the user that the transaction request was denied. However, if the user does qualify for exceeding their DSL via an ADSL override, ADSL management circuit 120 may initiate an authentication process to verify the user's identity. First, ADSL management circuit 120 may generate a confirmation request and provide the confirmation request to ATM 102 to display to the user. The confirmation request can be displayed to the user to allow the user confirm their intent to exceed the DSL. In some cases, the user may be accidentally attempting to exceed the DSL. As such, the confirmation request can be displayed to the user via ATM 102 to ensure the user desires to continue with the transaction. In some embodiments, the confirmation request indicates a phone number associated with mobile device 402 that a one-time-password (OTP), described in detail below, will be sent to. If multiple mobile devices 402 are associated with an account of the user, the confirmation request may include each phone number such that the user can select which mobile device 402 to receive the OTP. In some embodiments, the phone numbers are masked except for some portion of the number (e.g., only the last four digits may be visible).

If the user confirms the confirmation request (e.g., by pressing a confirmation button on ATM 102), the authentication process can continue. However, if the user denies the confirmation request (e.g., by pressing a denial button on ATM 102), financial institution computing system 110 can be notified and the transaction may be denied. In some embodiments, the confirmation request is not provided to the user, and instead, the transaction automatically proceeds under an assumption that the user intends to exceed the DSL.

If the user confirms the confirmation request, ADSL management circuit 120 may generate a one-time-password (OTP) and provide the OTP to mobile device 402 via network 126. In various embodiments, the OTP may be provided as a short message service (SMS) message, a push notification to a mobile application associated with ADSL application circuit 412, etc. Likewise, while in an authenticated session with ATM 102, ATM 102 can display a prompt to the user to enter the OTP.

The OTP can operate as an additional authentication factor that can be used to verify the user's identity. Advantageously, the OTP can only be used once, thereby eliminating a possibility of the OTP being used to confirm other transaction requests. In other words, the OTP may only be valid for the transaction associated with the authenticated session with ATM 102. The OTP can be of various forms. For example, the OTP may be a string of alphanumeric characters, a personal identification number (PIN), a pattern, or other various forms of passwords. In some embodiments, the OTP expires after a predetermined amount of time (e.g., 1 minute, 5 minutes, an hour, etc.) such that the OTP cannot be used after the predetermined amount of time. Expiration of the OTP can provide additional security as it ensures the users has more immediate access to mobile device 402.

In some embodiments, ADSL management circuit 120 encrypts the OTP prior to providing the OTP to mobile device 402. ADSL management circuit 120 can utilize various encryption techniques such as, for example, Advanced Encryption Standard (AES), Blowfish, SHA 1, RSA, or other encryption algorithms that can be used to protect the OTP in transit. By encrypting the OTP, even if the OTP is erroneously received by a system/device other than mobile device 402 (e.g., by a computing device of a hacker), the OTP can nonetheless be secured and inaccessible by the other system/device. If the OTP is encrypted by ADSL management circuit 120, ADSL application circuit 412 may include decryption instructions to decrypt the OTP such that it can be displayed to the user in an original format of the OTP (e.g., in plain text).

If received by mobile device 402 (e.g., via network interface 404), the OTP can be provided to ADSL application circuit 412. ADSL application circuit 412 can generate a display to display the OTP on mobile device 402 (e.g., by an output component of I/O device 414) in order to provide the OTP to the user. For example, the OTP may be displayed as a text message if ADSL application circuit 412 includes text message functionality.

Based on the OTP, the user can enter the OTP into ATM 102 to confirm the ADSL override. Depending on a form of the OTP and functionality of ATM 102, the user may type the OTP on a keyboard of ATM 102, draw a pattern on a touchscreen and/or with an electronic mouse of the ATM 102, tap numbers displayed on the ATM 102 to enter a PIN, etc. If the user incorrectly enters the OTP to ATM 102, ATM 102 may allow the user to re-enter the OTP or may deny the transaction to provide additional security to the transaction. In some embodiments, ATM 102 allows the user to incorrectly enter the OTP a predetermined amount of times (e.g., twice, three times, five times, etc.) before denying the transaction. If the user successfully enters the OTP, ATM 102 can generate and provide an approval notification to financial institution computing system 110 via network 126 indicating that the OTP was successfully entered such that the ADSL override can be approved. Responsive to the approval notification, financial institution computing system 110 can process the transaction. Once the transaction is successfully processed, financial institution computing system 110 can provide a completion notification to ATM 102 such that ATM 102 can dispense an amount of cash (or other currency) associated with the transaction.

As should be appreciated, the OTP provides various security benefits to adaptive transaction limit management system 400. In particular, the OTP can only be used for approving a single transaction and not for subsequent transactions. Further, incorporating a time limit on the OTP can ensure that if the OTP is not used for the present transaction, the OTP will not be valid for subsequent transaction requests. Additionally, as the OTP is provided to mobile device 402, access to the OTP may be restricted if mobile device 402 requires some other authentication to “unlock.” For example, mobile device 402 may perform a biometric verification of the user, may request a PIN of user associated with mobile device 402, etc., in order to unlock mobile device 402. In some embodiments, financial institution computing system 110 requires mobile device 402 to implement some verification process to unlock mobile device 402 before financial institution computing system 110 will provide the OTP to mobile device 402. In other words, financial institution computing system 110 may not provide the OTP to mobile device 402 if mobile device 402 automatically unlocks without performing any verification of what user is accessing mobile device 402.

In some embodiments, ADSL management circuit 120 only generates a particular number of OTPs over a predetermined time period. In other words, ADSL management circuit 120 may restrict a number of ADSL overrides during the time period by only allowing a certain number of OTPs (e.g., one OTP, two OTPs, five OTPs, etc.) to be generated during the time period. The time period can be any amount of time during which multiple ADSL overrides are not allowed to occur. For example, the time period may be a day, a week, a month, etc. In some embodiments, the time period is a fixed interval that starts and ends on a specific schedule. For example, the time period may be defined as a fixed interval of one day such that only a certain number of ADSL overrides can occur between 12:00 a.m. and 11:59 p.m. of a particular day. In some embodiments, the time period resets whenever a new ADSL override occurs. For example, if the time period is set to one day, ADSL management circuit 120 may restrict two ADSL overrides from occurring within 24 hours of one another. Alternatively, or additionally, ADSL management circuit 120 may set other various restrictions to limit a frequency of ADSL overrides. As some examples, ADSL management circuit 120 may limit the frequency of ADSL overrides based on a size of deposits, a frequency of deposits, opening/closing times of financial institutions (e.g., ADSL overrides can only occur between 9:00 a.m. and 5:00 p.m.), and/or other various criteria.

It should be noted that the ASDL override facilitated by the OTP may not affect an actual daily limit on an account of the user. If the user attempts a subsequent withdrawal transaction in the same day after applying the ASDL override, the subsequent transaction may be immediately declined and no additional option to go over the limit may be given. In this way, if the user exceeds their DSL via an ASDL override, no more withdrawals can occur to avoid further spending.

In some embodiments, mobile device 402 allows the user to “pre-stage” a transaction in order to retrieve the OTP prior to initiating the authenticated session with ATM 102. In this case, the user may request the OTP ahead of time via ADSL application circuit 412. Based on the request, ADSL application circuit 412 can generate and provide/transmit a pre-stage request to financial institution computing system 110. Based on the pre-stage request, ADSL management circuit 120 can determine whether the user qualifies for an ADSL override of their DSL. In some embodiments, financial institution computing system 110 may require that the pre-stage request indicates an anticipated amount associated with the upcoming transaction such that ADSL management circuit 120 can determine whether the user qualifies for the ADSL override based on the anticipated amount. If ADSL management circuit 120 determines the user does not qualify, ADSL management circuit 120 may provide a rejection notification to mobile device 402 to be displayed to the user. If the user is rejected, the rejection notification can save the user time such that they do not need to attempt a full transaction with ATM 102 before being denied. However, if ADSL management circuit 120 determines the user does qualify, ADSL management circuit 120 can generate and provide the OTP to mobile device 402 such that the user can receive the OTP prior to initiating the authenticated session with ATM 102. In this way, the user can have knowledge that the ADSL override will be approved and can provide the OTP to ATM 102 sooner as opposed to having to wait for the OTP to be generated and provided during the authenticated session.

In some embodiments, mobile device 402 facilitates NFC communication with ATM 102. Specifically, network interface 404 may include an NFC transceiver component that allows mobile device 402 to communicate with an NFC transceiver component of ATM 102. The user may provide data to and/or receive data from ATM 102 by “tapping” ATM 102 with mobile device 402. Tapping ATM 102 with mobile device 402 may include moving mobile device 402 within a certain range of ATM 102 (e.g., within 1 inch, within 1 foot, etc.) or may include initiating physical contact between mobile device and ATM 102. In some embodiments, ATM card 106 includes an NFC component (or other short-range communication component) that allows ATM card 106 to be tapped with ATM 102 to provide information related to ATM card 106 (e.g., an account number) to ATM 102. In this case, the user may be able to choose whether to choose to utilize mobile device 402 or ATM card 106 to initiate the authenticated session via a tap exchange.

Tapping ATM 102 with mobile device 402 can initiate a variety of data communication processes between ATM 102 and mobile device 402. For example, tapping ATM 102 with mobile device 402 may be used to initiate the authenticated session between ATM 102 and the user. In this case, mobile device 402 may create a unique transaction code similar to and/or the same as the unique transaction code generated by smart chip 108 that is utilized to verify a given transaction. The unique transaction code can be provided by mobile device 402 to ATM 102 during the NFC communication associated with the tapping. Said NFC communication can be utilized in addition to or alternatively from dipping ATM card 106 into ATM 102, tapping ATM card 106 with ATM 102, etc. as described above. As another example, mobile device 402 may provide the OTP to ATM 102 by tapping ATM 102 with mobile device 402. Advantageously, by providing the OTP via a tap exchange between mobile device 402 and ATM 102, the OTP may not be required to be human-readable. If the user is manually entering the OTP into ATM 102, the OTP may be required to be in a human-readable format (e.g., a string of alphanumeric characters, a PIN, etc.). However, if the OTP is provided via a tap exchange, the OTP can be directly provided in a machine-readable format such as in JavaScript Object Notation (JSON), comma-separated values (CSV), hexadecimal, binary, etc. Providing the OTP directly in machine-readable format can reduce/eliminate processing time required to convert the OTP to a human-readable format, generate a display screen to display the OTP to the user, etc.

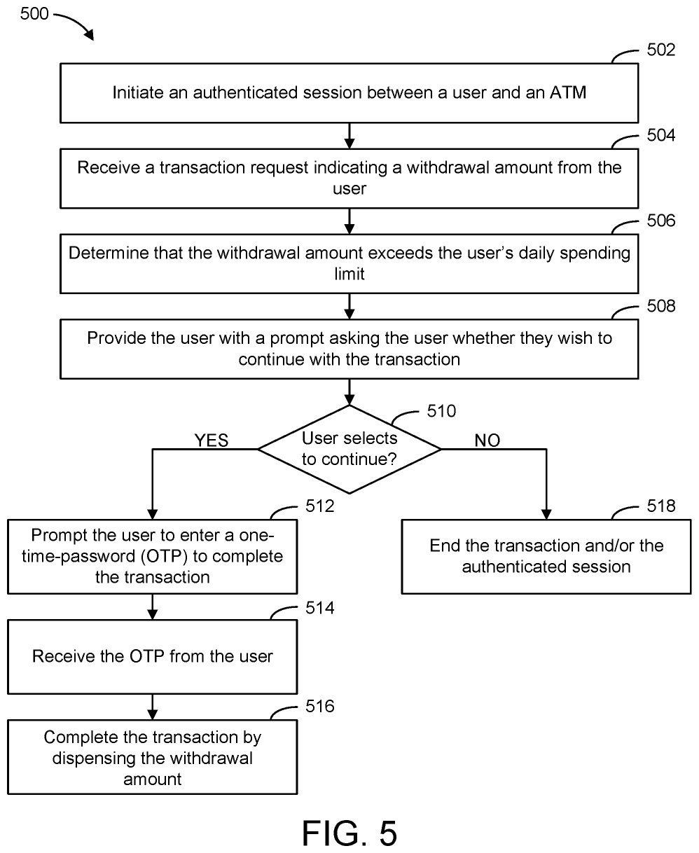

Referring generally to FIGS. 5-7, various processes for processing/completing transactions that require an ASDL override are shown, according to some embodiments. The processes described below in FIGS. 5-7 can be performed by various components of adaptive transaction limit management system 400 as described above with reference to FIG. 4. In some embodiments, the process described in FIGS. 5-7 work in tandem to process transactions that require an ASDL override.

Referring now to FIG. 5, a flow diagram of a process 500 for completing a transaction requested by a user is shown, according to some embodiments. In some embodiments, some and/or all steps of process 500 are performed by ATM 102 and/or components therein. In other words, process 500 illustrates how an ATM associated with a financial institution may handle processing of an ADSL override of a DSL. In some embodiments, process 500 can be performed by transaction devices other than the ATM. For example, process 500 may be performed by a POS device. In this case, the POS device may, instead of dispensing money, fulfill a different transaction (e.g., a purchase) that withdraws money from an account of the user.

An authenticated session between a user and an ATM is initiated at step 502. In some embodiments, the authenticated session is initiated based on the user swiping, dipping, and/or inserting an ATM card with a smart chip into a card reader of the ATM. In particular, step 502 may include inserting the ATM card with the smart chip into the card reader such that the ATM can access functionality of the smart chip for improve security of the authenticated session. In some embodiments, the authenticated session is initiated based on the ATM card with the smart chip being tapped with the card reader and/or another component of the ATM. In this case, the tap may include, for example, an NFC tap or other short-range communication tap between the ATM and the smart chip ATM card. Step 502 may also include further verification steps to initiate the authenticated session such as requiring the user to enter a PIN, a biometric identification, etc. As should be appreciated, step 502 can include various steps for verifying the user and the like. In some embodiments, step 502 is performed by ATM 102.

A transaction request indicating a withdrawal amount from the user is received at step 504. In step 504, the user may select (e.g., via buttons or a touchscreen of the ATM) an amount they wish to withdrawal. For example, the transaction request may indicate the user desires to withdrawal $500 from a checking account. In some embodiments, the transaction request indicating the withdrawal amount (also referred to herein as a transaction amount) is received by a tap exchange between a mobile device of the user and the ATM. In this case, the user may designate the withdrawal amount on the mobile device and tap the ATM with the mobile device to transmit the withdrawal amount during the authenticated session. In some embodiments, step 504 is performed by ATM 102.

A determination that the withdrawal amount exceeds the user's daily spending limit is made at step 506. In some embodiments, determining that the withdrawal amount exceeds the user's DSL is based on reception of a notification/indication from a financial institution computing system that the withdrawal amount exceeds the user's DSL. In this way, step 506 may include providing the withdrawal amount and/or the transaction request to the financial institution computing system and determining whether the withdrawal amount exceeds the user's DSL based on a response from the financial institution computing system. The user's DSL may be set by a financial institution, may be set by the user, and/or any other appropriate entity that has authority to set the user's DSL. For example, the user may set their own DSL to $200 such that they are limited to withdrawing $200 on a given day. If the withdrawal amount of the transaction request exceeds the user's DSL, process 500 can proceed to step 508. Of course, if the withdrawal amount does not exceed the user's DSL, process 500 can end and the transaction request can be processed normally as no ASDL override needs to be applied. In some embodiments, step 506 is performed by ATM 102.

The user is provided with a prompt asking the user whether they wish to continue with the transaction at step 508. The prompt can be displayed by the ATM such that the user can observe the prompt during the authenticated session. For example, the ATM may display text to the user such as “The withdrawal amount requested exceeds a daily spending limit of the associated account. Do you wish to continue?” In this way, the can be made aware of the fact that the withdrawal amount exceeds standard bounds of the associated account. In some embodiments, step 508 is performed by ATM 102.

Whether the user selects to continue is determined at step 510. The determination in step 510 can be based on various interactions the user may have with the ATM. For example, the user may touch a button on a touchscreen of the ATM or may physically type in “YES” or “NO” to the ATM. If the user continues with the transaction (step 510, “YES”), process 500 can continue to step 512. If the user does not continue with the transaction (step 510, “NO”), process 500 can proceed to step 518. In some embodiments, steps 508 and 510 are optional steps. For example, the ATM may be configured to assume the user's desires to make a withdrawal exceeding the daily spending limit. In this case, process 500 may automatically proceed to step 512 after step 506. In some embodiments, step 510 is performed by ATM 102.

The user is prompted to enter a one-time-password (OTP) to complete the transaction at step 512. As described above with reference to FIG. 4, the OTP can provide additional security to the transaction. In particular, the OTP can ensure that the user has immediate access to an authorized mobile device for receiving OTPs. In some embodiments, the prompt for the OTP may be displayed on a screen of the ATM and/or other appropriate ways of displaying the prompt to the user. It should be noted that process 500 may end at step 512 and/or other various steps in process 500 if an indication that the user does not qualify for an ASDL override is received. A determination may be an external computing system (e.g., a financial institution computing system) that the user does not qualify for the ASDL override, thereby nullifying the transaction request. The external computing system may provide the indication to the ATM, and, based on reception of the indication, the ATM can end the transaction and/or the authenticated session as the transaction request cannot be fulfilled. However, in some embodiments, the ATM may make the determination that the user does not qualify for the ASDL override instead of or in addition to the external computing system. In some embodiments, step 512 is performed by ATM 102.

The OTP is received from the user at step 514. Similar to the steps above, the user may enter the OTP in a variety of ways. For example, the user may enter the OTP by typing the OTP on a mechanical keyboard of the ATM, by pressing buttons on a touchscreen of the ATM, etc. In some embodiments, the OTP is received via a tap exchange between the mobile device of the user and the ATM. After the mobile device receives the OTP, the user can tap the ATM with the mobile device to provide the ATM with the OTP. In some embodiments, if the user incorrectly enters the OTP a certain number of times (e.g., once, twice, five times, etc.), the transaction may be denied and process 500 can terminate. In some embodiments, step 514 is performed by ATM 102.

The transaction is completed by dispensing the withdrawal amount at step 516. If step 516 is performed, the user should be verified for an ASDL override. As such, the withdrawal amount originally indicated by the transaction request in step 504 can be dispensed by the ATM. In some embodiments, step 516 includes providing an indication to the financial institution computing system indicating that the money (or other form of currency) was successfully provided to the user. In some embodiments, step 516 is performed by ATM 102.

The transaction and/or the authenticated session ends at step 518. If step 518 is performed, the user may have selected to not continue with the transaction. As such, process 500 can end to satisfy the user's selection to end the transaction. In some embodiments, step 518 is performed by ATM 102.

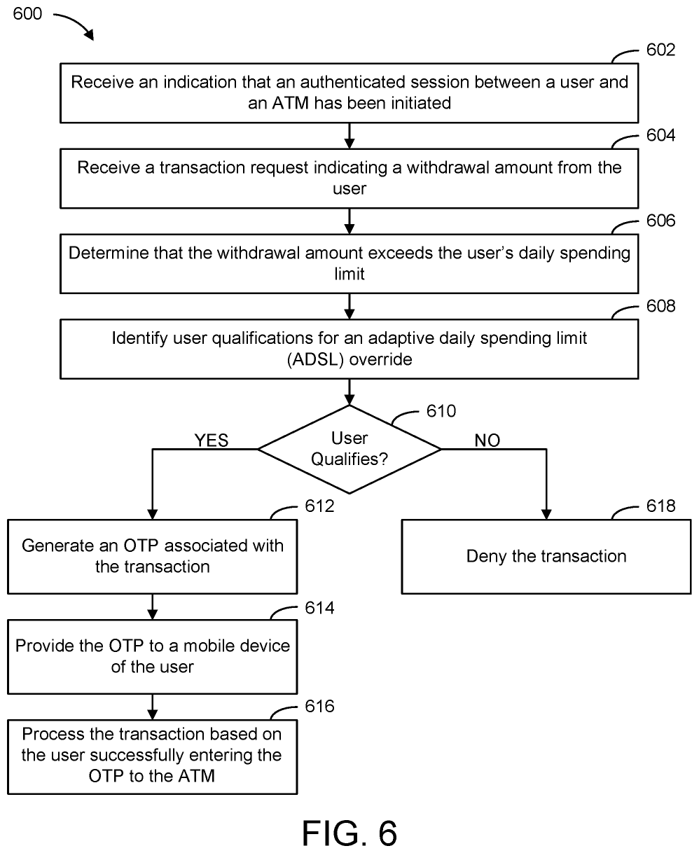

Referring now to FIG. 6, a flow diagram of a process 600 for processing a transaction is shown, according to some embodiments. Specifically, process 600 illustrates how a transaction requiring an ASDL override can be processed by a backend system (e.g., a financial institution computing system). In some embodiments, process 600 is performed by financial institution computing system 110 as described above with reference to FIGS. 1-4.

An indication that an authenticated session between a user and an ATM has been initiated is received at step 602. If the authenticated session is initiated, the ATM may provide the indication to the financial institution computing system such that the financial institution computing system can be notified that transaction processing may need to occur. In other words, based on the indication, the financial institution computing system can await further information regarding a transaction from the ATM. If the authenticated session is ever terminated (e.g., the user logs out of the ATM, the ATM is unresponsive, etc.), process 600 may terminate as well. In some embodiments, step 602 is performed by financial institution computing system 110.

A transaction request indicating a withdrawal amount is received from the user at step 604. During the authenticated session, the user may initiate a transaction indicates the withdrawal amount. In some embodiments, the transaction request is provided to the financial institution computing system by the ATM during the authenticated session. In other words, after the user provides information regarding the transaction request, the ATM can transmit said information to the financial institution computing system. In some embodiments, step 604 is performed by financial institution computing system 110.

A determination that the withdrawal amount exceeds the user's daily spending limit is made at step 606. The user's DSL may be some fixed amount that the user is generally not allowed to withdrawal more than in a given day (or other period of time). For example, the user's DSL may be set to $1000 such that the user cannot typically withdrawal more than $1000 in a given day. If the withdrawal request, in combination with previous withdrawal requests during the given day, would result in the DSL being exceeded, process 600 can proceed to step 608. Of course, if the withdrawal request does not result in the user exceeding their DSL, process 600 may terminate and the transaction can be processed normally (i.e., no ASDL needs to be applied). In some embodiments, step 606 is performed by financial institution computing system 110.

User qualifications for an adaptive daily spending limit override are identified at step 608. In some embodiments, step 608 may include performing some of the steps of process 300 as described above with reference to FIG. 3. Specifically, step 608 may include various determinations regarding whether the user qualifies for an ASDL override. For example, step 608 may include determining an age of the user's account, whether the withdrawal request exceeds maximum ASDL thresholds, whether the user has a registered mobile device associated with the account, whether the account exceeds a required minimum balance, if the user is utilizing an ATM card with a smart chip, etc. In some embodiments, the qualifications are identified based on ADSL indicator values that indicate certain qualities of the user and/or the account of the user. For example, a first ADSL indicator value may indicate whether another ADSL override has occurred in the past day, a second ADSL indicator value may indicate whether a minimum balance of the account of the user is sufficient for the ADSL override, etc. In some embodiments, step 608 is performed by financial institution computing system 110.

Whether the user qualifies for the ASDL override is determined at step 610. The determination in step 610 can be based on the user qualifications identified in step 608. In some embodiments, the user may be required to meet all qualifications to be authorized for the ASDL override. In some embodiments, the user may only be required to meet some of the qualifications (e.g., 3 out of 5 qualifications, 7 out of 10 qualifications, 9 out of 10 qualifications, etc.). If the user qualifies for the ASDL override (step 610, “YES”), process 600 can proceed to step 612. If the user does not qualify for the ASDL override (step 610, “NO”), process 600 can proceed to step 618. In some embodiments, step 610 is performed by financial institution computing system 110.

An OTP associated with the transaction is generated at step 612. Based on determining the user qualifies for the ASDL override, the OTP can be generated to provide additional security for the transaction. As described above with reference to FIG. 4, the OTP may include alphanumeric characters, a PIN, a pattern, etc. The OTP can be a one-use password that can be utilized by the user to verify the transaction. If the user is required to manually enter the OTP (e.g., to an ATM), the OTP may be generated as in a human-readable format. If the user can automatically provide the OTP (e.g., via a tap exchange between a mobile device of the user and the ATM), the OTP may be generated in a machine-readable format. In some embodiments, step 612 is performed by financial institution computing system 110.

The OTP is provided to a mobile device of the user at step 614. The OTP generated in step 612 can be provided to the mobile device such that the user can provide the OTP to the ATM to verify the transaction. The mobile device should be a registered mobile device associated with an account of the user that the user is attempting to withdrawal funds from. Step 614 may include sending an SMS message to the mobile device, pushing a notification to an application installed on the mobile device, etc. In effect, step 614 can include any appropriate process for providing to the OTP to the mobile device. In some embodiments, step 614 is performed by financial institution computing system 110.

The transaction is processed based on the user successfully entering the OTP to the ATM at step 616. If the user successfully enters the OTP to the ATM, the ATM may provide a notification to the financial institution computing system that the OTP was successfully entered. As such, the financial institution can proceed with processing the transaction as normal even though the withdrawal amount exceeds the DSL of the user. In other words, step 616 can result in an ASDL override being applied to the transaction such that the transaction request can be fulfilled even though the withdrawal amount exceeds the DSL. Accordingly, step 616 may include deducting the withdrawal amount from the user's account. If the transaction request indicates the withdrawal amount be provided to another entity (e.g., a merchant, a secondary financial institution, etc.), step 616 may include transferring the withdrawal amount to the entity. In some embodiments, step 616 is performed by financial institution computing system 110.

The transaction is denied at step 618. If step 618 is performed, the user may not qualify for the ASDL override. As such, the transaction request may be determined to be invalid and the transaction can be denied. In some embodiments, step 618 includes transmitting a denial notification to the ATM and/or the mobile device of the user such that the user can be provided with information regarding why the transaction was denied. In some embodiments, step 618 simply denies the transaction but allows the user to attempt further transactions. In some embodiments, step 618 transmits a message to the ATM that ends the authenticated session. In this case, the user may be required to initiate a new authenticated session if further transactions are desired. In some embodiments, step 618 is performed by financial institution computing system 110.

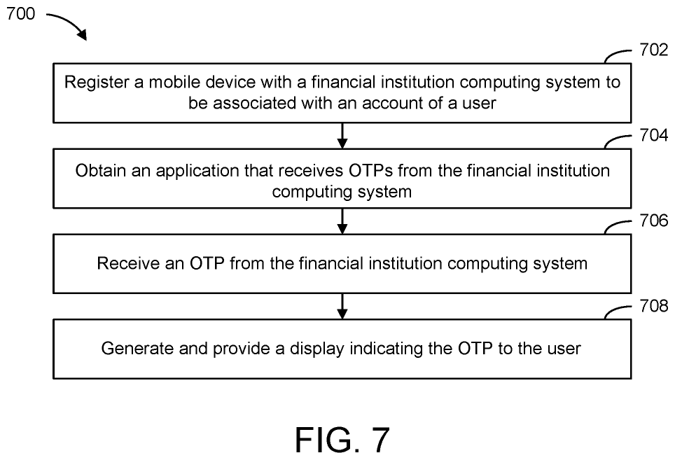

Referring now to FIG. 7, a flow diagram of a process 700 for providing a OTP to a mobile device of a user is shown, according to some embodiments. Process 700 can allow the user to be provided with the OTP such that a transaction requiring an ASDL override can be approved. In some embodiments, some and/or all steps of process 700 are performed by mobile device 402 and/or other components of adaptive transaction limit management system 400 as described above with reference to FIG. 4.

A mobile device is registered with a financial institution computing system to be associated with an account of a user at step 702. Specifically, step 702 can include registering the mobile device with the financial institution computing system of a financial institution such that the financial institution computing system can associate the mobile device with the account. By registering the mobile device, the mobile device can be authenticated to be provided OTPs in transactions where an ASDL override can be applied. Registering the mobile device can be performed in various ways such as, for example, a financial institution representative entering a phone number of the mobile device to the financial institution computing system, the user clicking an approval message sent to the mobile device, the user downloading an application associated with the financial institution on the mobile device and logging into the application, etc. In some embodiments, step 702 is performed by mobile device 402 and/or financial institution computing system 110.

An application that receives OTPs from the financial institution computing system is obtained at step 704. The application may be a mobile application developed by the financial institution that can be installed on the mobile device. In this case, step 704 may include downloading the application from an app store, a website of the financial institution, etc. In some embodiments, OTPs may be received by the mobile device in other ways such as by SMS message. In this case, the application may be an SMS messenger application that can allow the mobile device to receive SMS messages including OTPs. In effect, step 704 can include obtaining any appropriate application that can allow the mobile device to receive OTPs. In some embodiments, step 704 is performed by mobile device 402.

An OTP from the financial institution computing system is received at step 706. If an OTP is received by the mobile device, a transaction may be occurring that requires an ASDL override. In particular, if the OTP is received by the mobile device, the user may be approved for the ASDL override, but is required to enter the OTP to provide further verification of the transaction. The OTP may be received in various ways such as, for example, by a push notification to the application obtained in step 704, by an SMS message, etc. In some embodiments, step 706 is performed by mobile device 402.

A display indicating the OTP is generated and provided to the user at step 708. In some embodiments, step 708 is only performed if the OTP is meant to be manually entered by the user. If the user can automatically provide the OTP to an ATM or similar device, step 708 may not be performed. The display generated and provided in step 708 can include any appropriate display for providing the OTP to the user based on the application obtained in step 704. For example, the display may be in the form of a text message box in an SMS application, a text box in an application associated with the financial institution, etc. In this way, the user can be provided with the OTP such that the user can enter the OTP into the ATM or similar device. In some embodiments, step 708 is performed by mobile device 402.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more dedicated processors may execute instructions stored in the dedicated memory or may execute instructions otherwise accessible to the one or more dedicated processors. In some embodiments, the one or more dedicated processors may be embodied in various ways. The one or more dedicated processors may be constructed in a manner sufficient to perform at least the operations described herein. In some embodiments, the one or more dedicated processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more dedicated processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more dedicated processors may take the form of a single core processor, multi-core processor (e.g., a dual core processor, triple core processor, quad core processor, etc.), microprocessor, etc.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principles of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system, comprising:
a network interface; and
a processing circuit comprising one or more processors coupled to non-transitory memory, wherein the processing circuit is configured to:
provide a mobile application to a mobile device of a user associated with an account at a financial institution, the mobile application including decrypting instructions for decrypting an encrypted one-time password (OTP) such that the decrypted OTP is displayed to the user in plain text;
receive a transaction request from a transaction device, the transaction request associated with a payment card associated with the account at the financial institution and including a transaction amount;
determine that the transaction amount would cause a violation of a daily spending limit associated with the payment card;
determine that the user associated with the account qualifies for an adaptive daily spending limit (ADSL) override of the daily spending limit based on at least one of the account meeting a minimum balance requirement, an age of the account, or the payment card having a smart chip;
generate, in response to determining that the user qualifies for the ADSL override, a confirmation request asking whether the user wishes to exceed the daily spending limit, the confirmation request including a plurality of phone numbers associated with a plurality of mobile devices associated with the account at the financial institution for selection to receive an OTP associated with the transaction request, wherein each phone number of the plurality of phone numbers is partially masked;
display the confirmation request to the user via the transaction device;
receive a selection of the mobile device from the plurality of mobile devices from the user via the transaction device;
receive a confirmation of the confirmation request from the user via the transaction device;
generate, in response to receiving the confirmation from the user, the OTP;
encrypt the OTP;
provide the encrypted OTP to the mobile device of the user as a push notification to the mobile application;
receive, via the transaction device, the decrypted OTP in plain text from the user;
process the transaction request by applying the ADSL override of the daily spending limit responsive to receiving the decrypted; and
dispense an amount of cash equivalent to the transaction amount to the user via the transaction device.

2. The system of claim 1, wherein the payment card includes the smart chip, the ADSL override of the daily spending limit while processing the transaction request based at least in part on a determination that the transaction request originated from the payment card having the smart chip.

3. The system of claim 1, wherein the transaction device is an automated teller machine.

4. (canceled)

5. The system of claim 1, wherein the processing circuit is further configured to register the mobile device by associating the mobile device with the account of the user.

6. The system of claim 1, wherein the OTP expires after a predetermined amount of time.

7. (canceled)

8. The system of claim 1, wherein the processing circuit is further configured to:
receive a pre-stage request indicating a request for the OTP, the pre-stage request received prior to the transaction request; and
generate the OTP based on the pre-stage request.

9. A computer-implemented method comprising:
providing, by a financial institution computing system, a mobile application to a mobile device of a user associated with an account at a financial institution, the mobile application including decrypting instructions for decrypting an encrypted one-time password (OTP) such that the decrypted OTP is displayed to the user in plain text;
receiving, by the financial institution computing system, a transaction request from a transaction device, the transaction request associated with a payment card associated with the account at the financial institution and including a transaction amount;
determining, by the financial institution computing system, that the transaction amount would exceed a daily spending limit associated with the payment card;
determining, by the financial institution computing system, that the user associated with the account qualifies for an adaptive daily spending limit (ADSL) override of the daily spending limit based on at least one of the account meeting a minimum balance requirement, an age of the account, or the payment card having a smart chip;
generating, in response to determining that the user qualifies for the ADSL override, by the financial institution computing system, a confirmation request asking whether the user wishes to exceed the daily spending limit, the confirmation request including a plurality of phone numbers associated with a plurality of mobile devices associated with the account at the financial institution for selection to receive an OTP associated with the transaction request, wherein each phone number of the plurality of phone numbers is partially masked;
displaying, by the financial institution computing system, the confirmation request to the user via the transaction device;
receiving, by the financial institution computing system, a selection of the mobile device from the plurality of mobile devices from the user via the transaction device;
receiving, by the financial institution computing system, a confirmation of the confirmation request from the user via the transaction device;
generating, by the financial institution computing system in response to receiving the confirmation from the user, the OTP;
encrypting, by the financial institution computing system, the OTP;
providing, by the financial institution computing system, the encrypted OTP to the mobile device of the user as a push notification to the mobile application;
receiving, by the financial institution computing system via the transaction device, the decrypted OTP in plain text from the user; processing, by the financial institution computing system, the transaction request by applying the ADSL override of the daily spending limit responsive to receiving the decrypted OTP in plain text from the user; and
dispensing an amount of cash equivalent to the transaction amount to the user via the transaction device.

10. The method of claim 9, wherein the payment card includes the smart chip, the ADSL override of the daily spending limit while processing the transaction request based at least in part on a determination that the transaction request originated from the payment card having the smart chip.

11. The method of claim 9, wherein the transaction device is an automated teller machine.

12. (canceled)

13. The method of claim 9, further comprising registering, by the financial institution computing system, the mobile device by associating the mobile device with the account of the user.

14. The method of claim 9, wherein the OTP expires after a predetermined amount of time.

15. (canceled)

16. The method of claim 9, further comprising:
receiving, by the financial institution computing system, a pre-stage request indicating a request for the OTP, the pre-stage request received prior to the transaction request; and
generating, by the financial institution computing system, the OTP based on the pre-stage request.

17. A computer-implemented method, comprising:
providing, by a financial institution computing system, a mobile application to a mobile device of a user associated with an account at a financial institution, the mobile application including decrypting instructions for decrypting an encrypted one-time password (OTP) such that the decrypted OTP is displayed to the user in plain text;
receiving, by the financial institution computing system, an indication that an authenticated session between a transaction device and the user has been initiated;
receiving, by the financial institution computing system, a transaction request from the transaction device, the transaction request associated with a payment card associated with the account at the financial institution and including a transaction amount;
determining, by the financial institution computing system, that the transaction amount would exceed a daily spending limit associated with the payment card;
determining, by the financial institution computing system, that the user associated with the account qualifies for an adaptive daily spending limit (ADSL) override of the daily spending limit based on at least one of the account meeting a minimum balance requirement, an age of the account, or the payment card having a smart chip;
generating, in response to determining that the user qualifies for the ADSL override, by the financial institution computing system, a confirmation request asking whether the user wishes to exceed the daily spending limit, the confirmation request including a plurality of phone numbers associated with a plurality of mobile devices associated with the account at the financial institution for selection to receive an OTP associated with the transaction request, wherein each phone number of the plurality of phone numbers is partially masked;
displaying, by the financial institution computing system, the confirmation request to the user via the transaction device;
receiving, by the financial institution computing system, a selection of the mobile device from the plurality of mobile devices from the user via the transaction device;
receiving, by the financial institution computing system, a confirmation of the confirmation request from the user via the transaction device;
generating, by the financial institution computing system in response to receiving the confirmation from the user, the OTP;
encrypting, by the financial institution computing system, the OTP;
providing, by the financial institution computing system, the encrypted OTP to the mobile device of the user as a push notification to the mobile application;
receiving, by the financial institution computing system via the transaction device, the decrypted OTP in plain text from the user; and
completing, by the financial institution computing system in response to receiving the decrypted OTP in plain text from the user, the transaction request by dispensing an amount of cash equivalent to the transaction amount to the user via the transaction device.

18-20. (canceled)
